(19) United States
(12) Patent Application Publication
(10) Pub. No.: US 2008/0000157 A1
(43) Pub. Date: Jan. 3, 2008

(54) Method and device to motorize bladeset rotation angle of shutter

(76) Inventors: Keng-Hao Nien, Taichung City (TW); Shih-Hsien Huang, Hsinchu City (TW); Hong-Yang Hsu, Hu-Kou Township (TW); Ching-Tsung Wu, Hsinchu City (TW)

Correspondence Address: RABIN & Berdo, PC, 1101 14TH STREET, NW, SUITE 500, WASHINGTON, DC, 20005, US

(21) Appl. No.: 11/476,590

(22) Filed: Jun. 29, 2006

(51) Int. Cl. E06B 7/096

(52) U.S. Cl. 49/82.1

(57) ABSTRACT

A method to motorize bladeset rotation angle of a shutter including the following steps: resetting the bladeset to an origin point position at first when a start instruction is received, rotating the bladeset to a given target angle with respect to the origin point, and calculating a residual angle deviation to continuously rotate the bladeset to the given target angle when an instruction of the given rotation angle is received again during the operation. Further, a device provided to motorize bladeset rotation angle of a shutter includes an input interface for inputting instructions, a sensor for sensing an origin point position of the bladeset, a driver for driving the bladeset to rotate, and a controller for calculating and controlling the operation of the driver according to the origin point position and target angle, such that the bladeset is controlled to be rotated to the required angle.

### BACKGROUND OF THE INVENTION

1. Field of Invention

The present invention relates to a method and device to motorize bladeset rotation angle of a shutter, and more particularly, to a method and device to motorize bladeset rotation angle of a shutter which can rotate the bladeset of the shutter to a required angle rapidly when using, and provide a better convenience of operation.

2. Related Art

With an increasing progress on science and technology, the hope of people to continuously pursuit an enhanced life quality has been achieved, and many necessities of daily life also come into being automatized. As shown in FIGS. 1a and 1b, a conventional shutter generally includes a frame 20 pivotally disposed on the edge of the window (not shown) and a plurality of blades 21a pivotally disposed on two sides of the frame 20 in horizontal parallel. Two ends of each of the blades 21a are inserted into the pivot holes (not shown) on the inner side of the frame 20 through a pivot piece 210 which can be rotated and has an appropriate damping (used for preventing the bladeset from rotating automatically due to its own weight). The intermediate section of each of the blades 21a facing the room is linked up with each other through a pull rod 22 via looped links, such that the angle of the whole bladeset 21 of the shutter is adjusted by pushing and pulling the pull rod 22 manually.

However, the manual operation of adjusting the angle of the blade needs to be performed near the shutter. When a large number of shutters are required to be adjusted, they must be operated one by one, and also it is quite difficult to rotate each of the shutters to the required given angle correctly and nicely, thereby resulting in an inconvenience in operation and use.

Substantially, the operation may be motorized by using a motor device. Such a motorized mechanism must be in capable of being operated forward and backward, and generally a small DC motor can be used and a cell is used as a power. For the angle control, it is substantially possible that multiple shutters are operated simultaneously by using a remote control signal, however, if starting forward and backward rotations and stopping are controlled only depending on visualization by an operator, one similar case that multiple shutters are incapable of being simultaneously adjusted to a common given angle during an manual operation still occurs. Further, for the motorized device, a user can still operate manually, thus a motorization design must meet such a requirement and should not result in a conflict or damage to the device. Therefore, the present invention is to achieve the convenience in use and operation and to achieve a motorization of the bladeset angle of the shutter by using simple and reliable device and method.

### SUMMARY OF THE INVENTION

It is an object of the present invention to provide a method and device to motorize bladeset rotation angle of a shutter for overcoming the defect that the blade is incapable of being rapidly rotated to the required angle when the conventional shutter is used, and meanwhile meeting the requirement that the motorized device of the shutter also allows the user to adjust the bladeset manually.

Accordingly, to achieve the aforementioned objects, the present invention provides a method to motorize bladeset rotation angle of a shutter, which allows the user to operate by taking a given target angle as an instruction. The method comprises resetting the bladeset of the shutter to an origin point position at first when an instruction of starting the target angle is received; and then rotating the bladeset of the shutter to a given target angle with respect to the origin point, and calculating a residual angle deviation to continuously rotate the bladeset to the given target angle -when an instruction of the given rotation angle is received again during the operation. A preferred embodiment of the present invention provides five kinds of instruction selections such as an upper origin point, 45 degrees, 90 degrees, 135 degrees and a lower origin point, such that the bladeset of the shutter automatically rotates to the required rotation angle only according to one instruction from the user.

The present invention also provides a device to motorize bladeset rotation angle of a shutter, which comprises an input interface for inputting instructions; a sensor for sensing at least one origin point position of the bladeset, a driver for driving the bladeset to rotate, and a controller for calculating and controlling the operation of the driver according to the origin point position and the target angle, such that the bladeset is rotated to the required angle rapidly and accurately, thereby improving the convenience in use and operation. A moment restrictor is also provided in an embodiment of the present invention, such that only appropriate connecting moment is delivered between the driver and the bladeset, thus when the moment exceeds a preset range, the moment restrictor is departed from each other, thereby protecting the drive construction from being damaged and allowing the user to adjust the bladeset manually.

The method and device to motorize bladeset rotation angle of the shutter according to the present invention enables the bladeset of the shutter to be rotated to the given angle under an instruction, and allows a remote control operation, and meanwhile controls the bladeset of multiple shutters to be rotated to the target angle. Furthermore, the present invention enables the bladeset of the shutter to seek the origin point wisely, controls the rotation to the target angle accordingly, and allows updating of the requirement for the target angle during the process, thereby saving the time and power consumption and considering both the motorized and manual operations.

To have a further understanding of the objects, structures, characteristics, and functions of the present invention, the present invention is illustrated in detail accompanied by related embodiments and drawings a follows.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1a is a schematic view of a bladeset of a shutter according to the prior art;

FIG. 1b is a schematic view of a bladeset of a shutter in an operating condition according to the prior art;

FIG. 2 is a schematic view of assembly of the device to motorize bladeset rotation angle of the shutter according to the present invention;

FIG. 3 is a schematic view of function of the device to motorize bladeset rotation angle of the shutter according to the present invention;

FIG. 4 is an exploded schematic view of the body of the device to motorize bladeset rotation angle of the shutter according to the present invention;

FIG. 5 is a schematic view of local structures of a driver, a sensor, and a bladeset for rotation angle of the blades of the device to motorize bladeset rotation angle of the shutter according to the present invention;

FIG. 6 is a schematic view of input interface for rotation angle of the blade of the device to motorize bladeset rotation angle of the shutter according to the present invention;

FIG. 7 is a schematic view of rotation angle of the blade of the method to motorize bladeset rotation angle of the shutter of the present invention;

FIG. 8 is a schematic view of the flow of the method to motorize bladeset rotation angle of the shutter according to the present invention;

FIG. 9a is a perspective view of the gear set and elastic damping means of the device to motorize bladeset rotation angle of the shutter according to the present invention; and

FIG. 9b is an exploded view of the gear set and elastic damping means of the device to motorize bladeset rotation angle of the shutter according to the present invention;

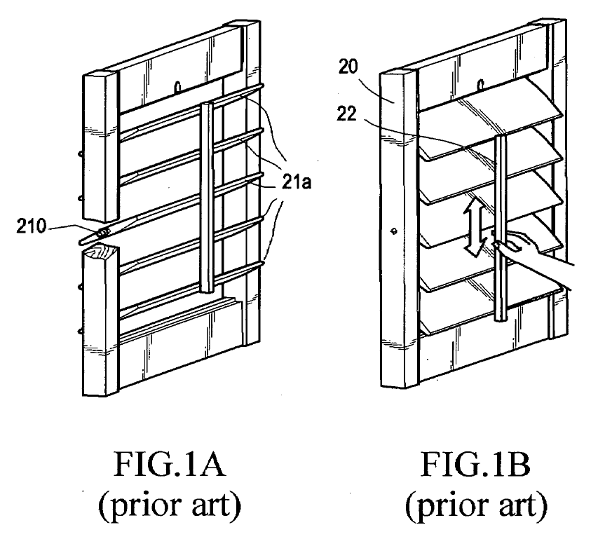

### DETAILED DESCRIPTION OF THE INVENTION

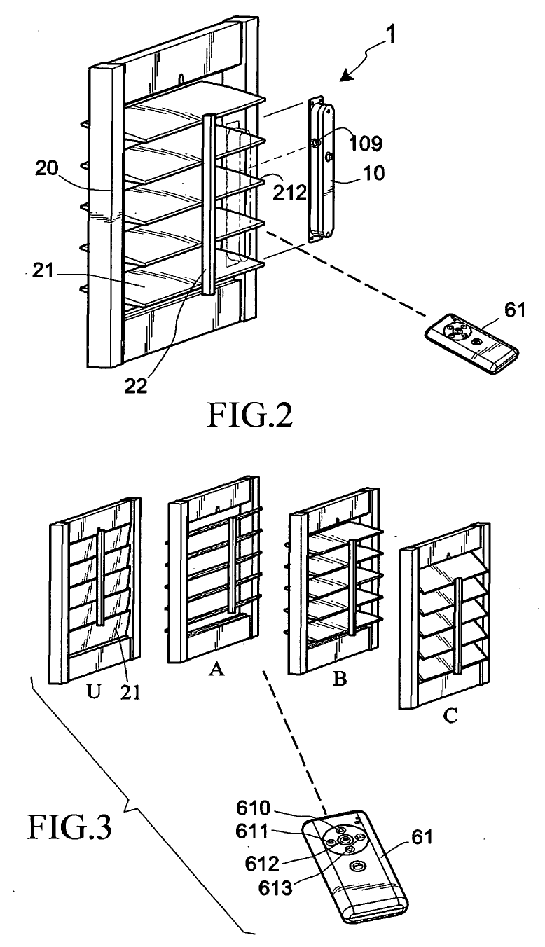

Please refer to FIGS. 2 and 3 of schematic views of assembly and function of the present invention. As shown in FIGS. 2 and 3, the device 1 to motorize bladeset rotation angle of shutter of the present invention comprises a body 10 buried on one side of a frame 20 of the shutter, an output shaft 109 fitted with one end of one of the blades of the bladeset 21 through an end cover 212 for transmission. The body 10 can be controlled remotely with an input interface 61 by transmitting signals in a wired or wireless manner, and the wireless communication manner may be a radio frequency or an infrared signal manner. Here, each of the blades of bladeset is pivotally connected to a corresponding spindle hole of the frame 20 in a smoothly-rotatable manner, such that the output of the device 1 is controlled to be sufficient to drive the bladeset 21 to rotate. The shutter includes a pull rod 22 joining each of the blades of bladeset 21 together for a linked-up control, and allows a manual operation by the user. During a motorizing operation, a plurality of keys of the given target angle on the input interface 61, for example an upper origin point key 610, a first target angle (45 degrees) key 611 a second target angle (90 degrees) key 612, a third target angle (135 degrees) key 613, etc., is used for outputting an angle instruction to the body 10, such that the bladeset 21 of the shutter automatically rotates to the required upper origin point U, the first target angle A, the second target angle B, the third target angle C, etc.

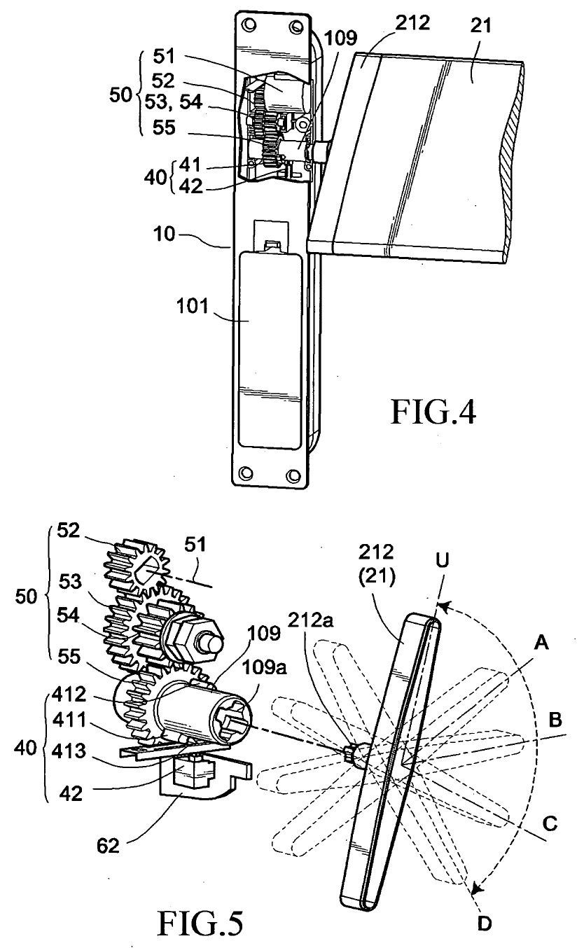

Please refer to FIG. 4 of an appearance and local exploded view of the body 10 of one embodiment of the present invention. The body 10 generally is a box buried and fixed in the frame of shutter (not shown), and an output shaft 109 is connected to an end cover 212 fitted with one end of one of the blades of bladeset 21 for transferring a rotary force. The power coming from a battery (not shown) in the body 10 is controlled to drive a motor 51 driven. A battery cover 101 may be taken off for replacing the battery. Generally, the body 10 of the device to motorize bladeset rotation angle of shutter of the present invention comprises a receiver (not shown), for example an infrared signal receiving circuit, for receiving a control instruction; a sense 40 for sensing at least one origin point position of the bladeset 21, a driver 50 for driving the bladeset 21 to rotate, and a controller (which contains a microprocessor and a circuit) for calculating and controlling the operation of the driver 50 according to the origin point position. Here, the sensor 40 includes an actuating piece 41 connected to the output shaft 109 and a switch 42, and the driver 50 includes a motor 51 and a reduction gear set (such as the gears 52, 53, 54, 55 described below), for driving the output shaft 109. When the controller receives the instruction signal from the input interface, the driver 50 is controlled to determine the origin point position of the bladeset 21 by utilizing the sensor 40, and then the bladeset 21 is further driven to the target angle.

FIG. 5 shows a local structure of one embodiment of the driver 50, the sensor 40, and the bladeset 21 (represented by the end cover 212). The output shaft of the motor 51 is connected to a motor gear 52, a big gear 53 is engaged with the motor gear 52, a small gear 54 and the big gear 53 are set coaxially, which are connected with each other or have a moment restrictor, an output gear 55 is fixed to the output shaft 109, and the above motor 51, motor gear 52, and coaxial gear set (including the big gear 53 and the small gear 54) and output shaft 109 together form the driver 50 disposed in the body 10, such that the coaxial gear set (including the big gear 53 and the small gear 54) and the output shaft 109 may be positioned and rotated pivotally, and thereby the rotary force of the motor 51 is decreased in speed and increased in force and then transmitted to the output shaft 109. The output shaft 109 forms a cross shaped (or another suitable shape) spindle hole 109a to transfer the rotary force in combination with a protrusion 212a corresponding to the end cover 212 of the blade. The motor 51 preferably is a stepping motor, by the driving pulse of which the rotation angle is controlled exactly. At least one actuating point is set on the output shaft 109, and here two actuating protrusions 411, 412 respectively correspond to the upper origin point U and lower origin point D of the bladeset 21. The actuating protrusions 411, 412 press a switch 42 for an actuation through a spring 413, such that the switch 42 produces an ON signal when the output shaft 109 and the bladeset 21 are rotated to near the positions of upper, lower limits of a rotatable range of the blade (that is the upper origin point and the lower origin point), while produces an OFF signal when they are at other intermediate angles. The controller (not shown) controls the bladeset 21 to be rotated and positioned according to the signals, and once the controller determines that the bladeset 21 has reached the upper or lower origin point U or D, the blades are accordingly controlled to be rotated to other positioning angles A, B, C etc. The above spring 413 and switch 42 (fixed on a circuit board 62) are both fixed within the body 10, and form the sensor 40 together with the actuating protrusions 411, 412.

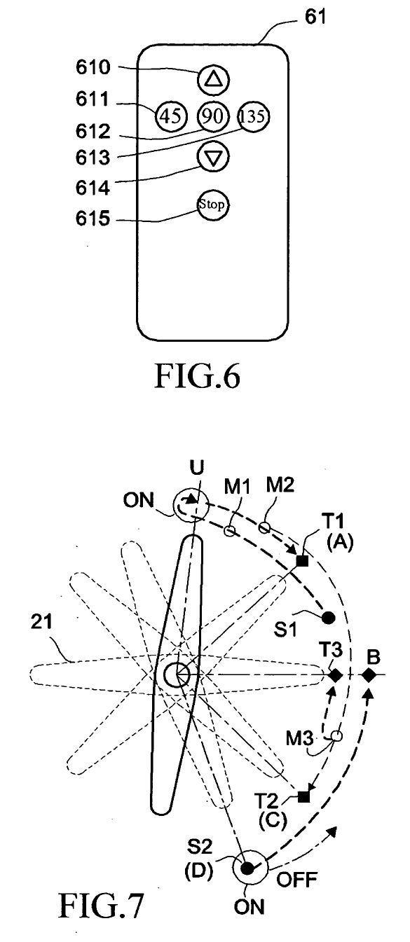

FIG. 6 shows an embodiment of the input interface 61 of the present invention. The input interface preferably is a remote control, such that multiple shutters may be remotely controlled simultaneously with a radio frequency or an infrared signal. The input interface 61 is provided with a plurality of given target angle keys, for example the upper origin point key 610, the first target angle key 611, the second target angle key 612, the third target angle key 613, the lower origin key 614 and a stop key 615. Accordingly, the user only needs to choose to press any one of the target angle keys 610, 611, 612, 613, and 614 to send out the instruction signal, the device of the present invention automatically performs the angle control. During the performance, the user may change the target angle at any time or may press the stop key 615 to stop the rotation of the bladeset 21.

The control method of the present invention is illustrated by taking FIG. 7 as an example; FIG. 7 is a schematic view of the rotation angle of the bladeset 21. For example, when starting from an initial point S1, the blade first rotates upwards until reaching the upper origin point U (the sensor is ON), and then the controller counts the angle (with time or in pulse number) inversely to rotate the blade to the target angle TI. During this period, for example being at the intermediate point M1 before reaching the upper origin point U, even though the setting of the target angle is changed, the controller continues to perform an upward rotation to turn to the control of a new target angle after finding the upper origin point U (if the target angle is the upper origin point U or the lower origin point D, the rotation proceeds upwards, downwards to the end at any time). If the instruction of a new target angle is received when the upper origin point U is exceeded and an intermediate point M2 is reached, the controller reckons a subsequent travel with the current position and continues to rotate the blade to the new target angle T2. For example, if again receiving the instruction of a new target angle at an intermediate point M3 before T2 is reached, the controller inversely rotates the blade to the new target angle T3 since the position has been exceeded. Another example on control is that, the blade 21 originally stops at the lower origin point D, the sensor being ON, and when being restarted, the controller is incapable of determining whether the blade 21 is at the upper origin point U or at the lower origin point D (since the blade may be moved manually -by the user when it is stopped), so the controller still controls the blade to rotate upwards. The sensor 40 is checked at real time, and if it is found that the signal has changed from ON to OFF, it is known that the blade 21 is at the lower origin point D originally, and the blade can be controlled to rotate towards the target angle (that is the second target angle B) accordingly.

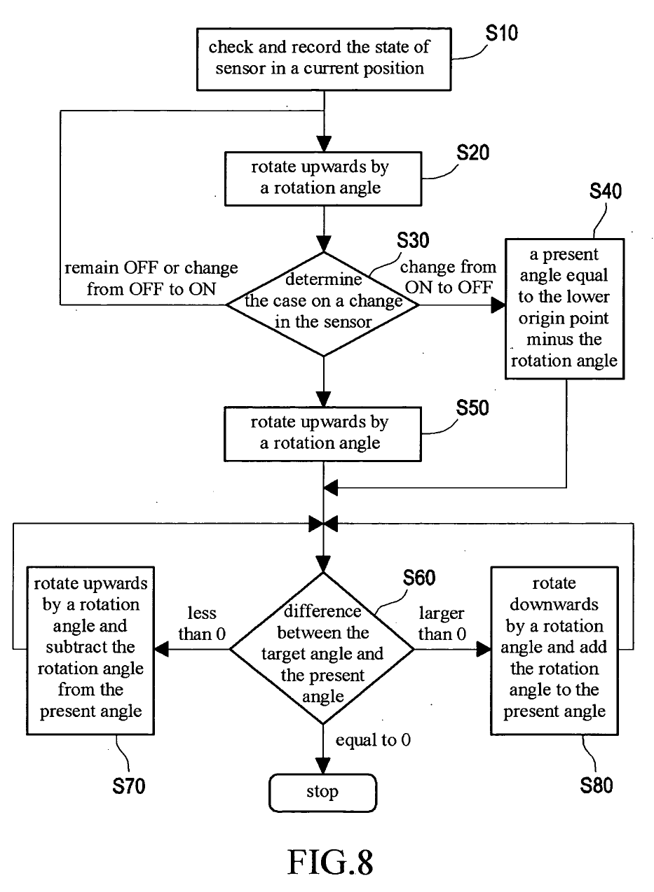

The method to motorize the bladeset rotation angle of the shutter of the present invention is still illustrated by referring to FIG. 8 which is a flow diagram. When receiving a start instruction which causes the blade to start from a stop state, the state of sensor in a current position is checked and recorded (step SI 0). The blade rotates upwards by a certain rotation angle (step S20). The case on a change in the sensor is determined (step S30). If the sensor 40 changes from ON to OFF, it represents that the blade originally is at the lower origin point, so a present angle equals to the lower origin point minus the rotation angle (step S40), the rotation continues to be controlled accordingly. If the sensor remains OFF or has changed from OFF to ON just now, it represents that the upper origin point U has still not been reached (or been entered just now), the controller may continues to rotate the blade by a certain rotation angle for a re-determination, and when it is determined that the sensor remains ON, it represents that the blade now is at the upper origin point, and a present angle equals to the upper origin point (step S50), and the blade may be rotated downwards to the target angle accordingly. During the operation, a difference between an up-to-date target angle and a present angel is viewed circularly (step S60). If the present angle is larger than the target angle, the blade is rotated upwards, that is the blade is rotated upwards by a rotation angle and the rotation angle is subtracted from the present angle (step S70). If the present angle is less than the target angle, the blade continues to be rotated downwards, that is the blade is rotated downwards by a rotation angle and the rotation angle is subtracted from the present angle (step S80). If the difference equals to 0, the rotation is stopped. In this embodiment, the rotation angle modified each time is represented by 5 degrees, and practically other angle values may also be used for operation.

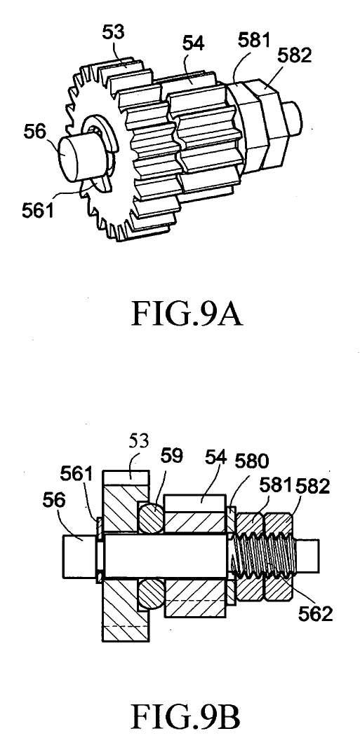

In the present invention, the motor functions as a power which is slowed down by the reduction gear set, such that the output shaft generates a sufficient moment, correspondingly, when the pull rod or blade is rotated by manual operation, or a barrier is encountered or a dead point is reached during the blade rotation, an external force is input from the blade, which relatively drives an internal driver means to rotate instantly and rapidly, such that the driver means is easy to be damaged. Therefore, in the present invention, a moment restrictor is designed on the transmitting path between the transmitting shaft and the motor output shaft, such that the transmitting force detaches when the external force or load exceeds a preset value, and thereby avoiding the driver means from being damaged by the external force. In the embodiment as shown in FIG. 5 of the present invention, an elastic damping structure is designed on the coaxial reduction gear, and as shown the perspective and exploded view of FIGS. 9a and 9b, the big, small gears 53, 54 are slidably arranged on the shaft rod 56, and an elastic piece, for example colloidal silica or a rubber ring 59, is clamped therebetween, which is firmly locked to an appropriate pressure by utilizing the shoulder region of one end of the shaft rod 56 or a snap ring 561 as well as a screw thread 562, a washer 580 and dual lug nuts 581, 582 at the other end, and thereby generating an appropriate friction rotation moment. Thus a moment is set sufficient to be output from the inside to drive the blade to rotate, and is capable of protecting the internal driver means from being damaged by the undue moment input from the outside via an overload slip. The moment restrictor naturally may be designed between the output gear and the output shaft, or on the motor gear.

The method and device to motorize bladeset rotation angle of the shutter of the present invention at least can achieve the following functions.

1. The present invention enables the bladeset of the shutter to be rotated to the given angle under an instruction, and allows a remote control operation, and meanwhile controls the bladeset of multiple shutters to be rotated to the target angle;

2. The present invention enables the bladeset of the shutter to seek the origin point wisely, controls the rotation to the target angle accordingly, and allows updating of the requirement for the target angle during the process, thereby saving the time and power consumption and considering both the motorized and manual operations.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method to motorize bladeset rotation angle of a shutter, performing the following steps after receiving a start instruction according to the state of a sensor for the bladeset position:
checking and recording whether the current state of the sensor is ON or OFF;
controlling the bladeset to rotate by a rotation angle in a first direction;
determining the change in the sensor, if the sensor remains OFF or changes from OFF to ON, performing the step of controlling the bladeset to rotate by a rotation angle in the first direction; if the sensor remains ON, determining that a present angle is an upper origin point; and if the sensor changes from ON to OFF, determining that the present angle equals to a lower origin point minus the rotation angle; and
circularly viewing the difference between a target angle and the present angle, and if the target angle is larger than the present angle, rotating the bladeset a rotation angle towards a second direction opposite to the first direction with the present angle plus the rotation angle; if the target angle is less than the present angle, rotating the bladeset a rotation angle towards the first direction with the present angle minus the rotation angle; and repeating the above viewing until the target angle equals to the present angle.

2. The method to motorize bladeset rotation angle of a shutter as claimed in claim 1, wherein the rotation angle is 5 degrees.

3. A device to motorize bladeset rotation angle of a shutter, wherein each blade of the bladeset of shutter is connected to a pull rod for a linked-up control, and the each blade of the bladeset of shutter is socketed with an output shaft through an end cover for a transmission and is pivotally connected to the corresponding shaft hole of a frame, the device comprising:
a sensor for sensing at least one origin point position of the bladeset, and comprising an actuating piece and a switch, the actuating piece being connected to the output shaft;
a driver comprising a motor and a reduction gear set, the gear set being connected to the output shaft, thereby driving the output shaft to rotate the bladeset of the shutter; and
a controller receiving a signal of instruction of a target angle for controlling the driver and determining the origin point position of the bladeset through the sensor, and driving the bladeset to rotate to the target angle.

4. The device to motorize bladeset rotation angle of a shutter as claimed in claim 3, further comprising:
a body for accommodating the sensor, the driver and the controller; and
an input interface for transmitting the instruction signal to the controller.

5. The device to motorize bladeset rotation angle of a shutter as claimed in claim 3, further comprising a battery disposed in the body for providing the required power.

6. The device to motorize bladeset rotation angle of a shutter as claimed in claim 3, wherein the motor is a stepping motor.

7. The device to motorize bladeset rotation angle of a shutter as claimed in claim 3, wherein the reduction gear set comprises a motor gear, a coaxial gear set and an output gear, the motor gear is fixedly connected to the output shaft of the motor, and the coaxial gear set comprises a small gear and a big gear engaged with the motor gear, and the output gear is fixedly set on the output shaft.

8. The device to motorize bladeset rotation angle of a shutter as claimed in claim 7, wherein the big gear and small gear are slidably arranged on a shaft rod, and an elastic piece is clamped therebetween for remaining an appropriate transmitting moment.

9. The device to motorize bladeset rotation angle of a shutter as claimed in claim 3, wherein the output shaft is provided with at least one actuating point, and has actuating protrusion corresponding to at least one origin point angle of the bladeset for pushing and pressing the switch of sensor to actuate.

10. The device to motorize bladeset rotation angle of a shutter as claimed in claim 3, wherein the output shaft forms a shaft hole for transferring a rotary force in combination with the protrusion correspondingly formed by the end cover of the blade.

11. The device to motorize bladeset rotation angle of a shutter as claimed in claim 9, wherein the output shaft forms a shaft hole for transferring a rotary force in combination with the protrusion correspondingly formed by the end cover of the blade.

12. The device to motorize bladeset rotation angle of a shutter as claimed in claim 9, wherein the shaft hole of the output shaft is of a cross shape.

13. The device to motorize bladeset rotation angle of a shutter as claimed in claim 4, wherein the input interface outputs an angle instruction to the body in a wired or wireless communication manner.

14. The device to motorize bladeset rotation angle of a shutter as claimed in claim 13, wherein the input interface is a remote control which communicates in a radio frequency or an infrared manner.

15. The device to motorize bladeset rotation angle of a shutter as claimed in claim 4, wherein the input interface is provided with a plurality of given target angle keys.

16. The device to motorize bladeset rotation angle of a shutter as claimed in claim 15, wherein the plurality of given target angle keys comprises at least a part of an upper origin point key, a first target angle key, a second target angel key, a third target angle key, a lower origin point key, and a stop key.

17. The device to motorize bladeset rotation angle of a shutter as claimed in claim 15, wherein the first target angle is 45 degrees.

18. The device to motorize bladeset rotation angle of a shutter as claimed in claim 15, wherein the second target angle is 90 degrees.

19. The device to motorize bladeset rotation angle of a shutter as claimed in claim 15, wherein the third target angle is 135 degrees.
